(19) United States
(12) Patent Application Publication
(10) Pub. No.: US 2016/0142433 A1
(43) Pub. Date: May 19, 2016

(54) INFORMATION ASSESSMENT SYSTEM, INFORMATION ASSESSMENT APPARATUS, AND INFORMATION ASSESSMENT METHOD

(71) Applicant: Masami NASU, Kanagawa (JP)

(72) Inventor: Masami NASU, Kanagawa (JP)

(21) Appl. No.: 14/935,958

(22) Filed: Nov. 9, 2015

(30) Foreign Application Priority Data
Nov. 13, 2014 (JP) 2014-230736

(51) Int. Cl. H04L 29/06

(52) U.S. Cl. CPC H04L 63/1433

(57) ABSTRACT

An information assessment system includes: an information management apparatus; and an information assessment apparatus connected to an information device via a first network and connected to the information management apparatus via a second network. The information management apparatus includes: an acquisition unit configured to acquire information about a setting state of the information device, an assessment processing unit configured to assess setting contents of the information device based on the acquired information and generate assessment result information, and a transmitting unit configured to transmit the assessment result information to the information management apparatus. The information management apparatus includes: a receiving unit configured to receive the assessment result information from the information assessment apparatus; and an output unit configured to output assessment-result output information containing findings on setting contents in a management area, in which the information device is arranged, based on the received assessment result information.

### CROSS-REFERENCE TO RELATED APPLICATIONS

The present application claims priority to and incorporates by reference the entire contents of Japanese Patent Application No. 2014-230736 filed in Japan on Nov. 13, 2014.

### BACKGROUND OF THE INVENTION

1. Field of the Invention

The present invention relates to a technique for assessing an information device(s) and, more particularly, to an information assessment system, an information assessment apparatus, and an information assessment method for assessing an information device(s).

2. Description of the Related Art

In recent years, concerns about threats that can be caused by access to an information device such as a multifunction peripheral, a printer, or a projector via the Internet have arisen. The threats stem from the background that the Internet has become commonplace and such information devices have been highly functional. From this background, it has become important to apply security management of a security level equivalent to that of personal computers and network servers to such information devices.

At installation of an information device, security settings of the information device are generally performed by a seller or the like of the information device, and therefore security management will be carried out appropriately. However, if an environmental change such as relocation of an office, an organizational change, or a change in network configuration during operation should occur, a large load will be placed on an administrator(s) of the information device. This is because to maintain the settings appropriately is not easy due to complexity of setting items of the information device and the like.

Such security management on user's side has been known in, for example, Japanese Patent No. 5139485 (patent document 1). A remote security-assessment system aimed at reducing a burden of visiting a client's site to maintain security is disclosed in the patent document 1. The remote security-assessment system includes a to-be-assessed server including an agent, an information collecting server configured to transmit to the agent a command to conduct security assessment of the to-be-assessed server and transmit assessment data, which is a result of the security assessment, via a public communication network, and a assessment server configured to analyze the assessment data received from the information collecting server.

A technique aimed at reducing a burden, which is placed on a network administrator(s), of carrying out security management of a printing apparatus is disclosed in Japanese Laid-open Patent Application No. 2005-115519 (patent document 2). The patent document 2 discloses a configuration including a security assessment device and configured to set a security level of the printing apparatus, provide a notice of a assessment result, and restrict printing depending on the security level.

The conventional technique disclosed in the patent document 1 requires that the information collecting server be placed on the user's side. This technique is also disadvantageous in that settings can be checked only on a per-device basis and incapable of conducting assessment on a per-management-area basis, e.g., on a per-office basis. Accordingly, this technique is not sufficient from the perspective of reducing the burden placed on the administrator(s) on the user's side. The conventional technique in the patent document 2 is disadvantageous in that it is difficult to maintain security if an office environment should change. This technique is also incapable of assessing settings on a per-management-area basis, e.g., on a per-office basis.

Therefore, there is a need for an information assessment system, an information assessment apparatus, and an information assessment method capable of assessing setting contents of an information device(s) in a management area where the information device(s) is installed, without transmitting information about the setting state(s) of the information device(s) acquired from the information device(s) to the outside of a network, to which the information device(s) is connected, and adapting to an environmental change in the management area.

### SUMMARY OF THE INVENTION

It is an object of the present invention to at least partially solve the problems in the conventional technology.

An information assessment system includes: an information management apparatus; and an information assessment apparatus connected to at least one information device via a first network and connected to the information management apparatus via a second network. The information assessment apparatus includes: an acquisition unit configured to acquire information about a setting state of the at least one information device from the at least one information device; an assessment processing unit configured to assess setting contents of the at least one information device based on the acquired information about the setting state of the at least one information device and generate assessment result information; and a transmitting unit configured to transmit the assessment result information generated by the assessment processing unit to the information management apparatus connected via the second network. The information management apparatus includes: a receiving unit configured to receive the assessment result information from the information assessment apparatus; and an output unit configured to output assessment-result output information containing findings on setting contents in a management area, in which the at least one information device is arranged, based on the received assessment result information.

An information assessment apparatus is connected to at least one information device via a first network and connected to an information management apparatus via a second network. The information assessment apparatus includes: an acquisition unit configured to acquire information about a setting state of the at least one information device from the at least one information device; an assessment processing unit configured to assess setting contents of the at least one information device based on the acquired information about the setting state of the at least one information device and generate assessment result information; and a transmitting unit configured to transmit the assessment result information generated by the assessment processing unit to the information management apparatus connected via the second network. The information management apparatus outputs assessment-result output information containing findings on setting contents in a management area, in which the at least one information device is arranged, based on the assessment result information received from the information assessment apparatus.

An information assessment method is carried out between an information assessment apparatus and an information management apparatus. The information assessment device is connected to at least one information device via a first network and connected to the information management apparatus via a second network. The information assessment method includes: acquiring, by the information assessment apparatus, information about a setting state of the at least one information device from the at least one information device via the first network; generating, by the information assessment apparatus, assessment result information by assessing setting contents of the at least one information device based on the information about the setting state of the at least one information device acquired at the acquiring; transmitting, by the information assessment apparatus, the generated assessment result information to the information management apparatus connected via the second network; receiving, by the information management apparatus, the assessment result information from the information assessment apparatus; and outputting, by the information management apparatus, assessment-result output information containing findings on setting contents in a management area, in which the at least one information device is arranged, based on the assessment result information.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a device management system according to an embodiment;

FIG. 2 is a functional block diagram illustrating a configuration of the device management system according to the embodiment;

FIG. 3 is a sequence diagram illustrating processing from regular reporting to report storing of security management to be performed by the device management system according to the embodiment;

FIG. 4 is a diagram illustrating a data structure of report data accumulated in a device-information storing unit according to the embodiment;

FIG. 5 is a flowchart illustrating an assessment process to be performed on a per-information-device basis and on a per-management-area basis by an assessment processing unit according to a specific embodiment;

FIGS. 6A and 6B are diagrams illustrating management data for an information device and a data structure of an assessment policy, respectively, used by the device management system according to the embodiment;

FIG. 7 is a diagram illustrating a data structure of per-information-device assessment result data stored in an assessment-result storing unit according to the embodiment;

FIG. 8 is a diagram illustrating a data structure of per-management-area security-assessment result data stored in the assessment-result storing unit according to the embodiment;

FIG. 9 is a sequence diagram illustrating processing from assessment result viewing to changing a setting of the security management to be performed by the device management system according to the embodiment;

FIGS. 10A to 10C are diagrams illustrating graphical user interfaces displayed on an administrator's terminal 170 according to the embodiment;

FIGS. 11A and 11B are diagrams illustrating other graphical user interfaces displayed on the administrator's terminal 170 according to the embodiment;

FIG. 12 is a flowchart illustrating an assessment process to be performed for each information device by a assessment server according to a further embodiment;

FIG. 13 is a flowchart illustrating an assessment process to be performed for each management area by a device-security management server according to the further embodiment; and

FIG. 14 is a diagram illustrating a hardware configuration of the assessment server according to the present embodiments.

### DETAILED DESCRIPTION OF THE PREFERRED EMBODIMENTS

Exemplary embodiments of the present invention are described below. It should be noted that embodiments are not limited to those described below. In the embodiments described below, an information management system and an information assessment apparatus are exemplified as a device management system and an assessment server, respectively.

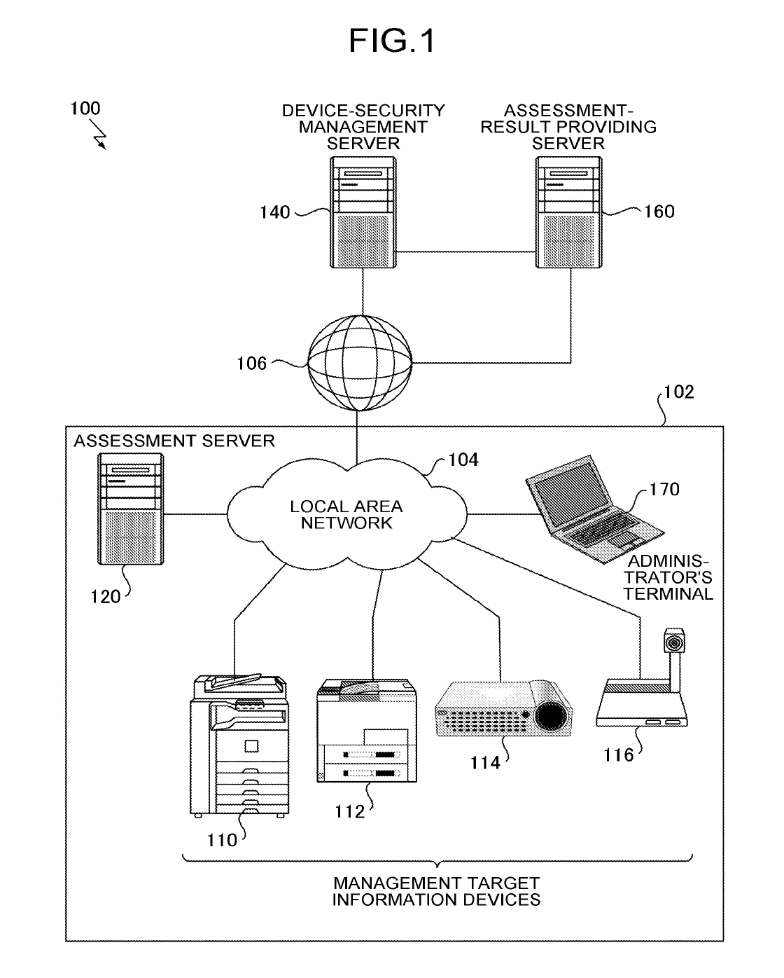

FIG. 1 is a schematic diagram illustrating a device management system 100 according to an embodiment. As illustrated in FIG. 1, the device management system 100 includes an assessment server 120 configured to assess security of information devices, a device-security management server 140 configured to manage the information devices to be managed, and an assessment-result providing server 160 configured to provide a security assessment result to a user. The user may typically be an administrator on the service user's side.

FIG. 1 exemplifies a predetermined office 102 managed by the device-security management server 140. One or more information devices 110, 112, 114, and 116 are installed in the office 102. The office 102 is one of areas (hereinafter, “management areas”), which are units managed in the embodiment. The one or more information devices 110 to 116 in the office 102 are registered as management targets of the device-security management server 140.

The office 102 includes a local area network (LAN) 104, which may be a wired, wireless, or a combination of wired and wireless network. The management target information devices 110 to 116 are connected to the LAN 104. The LAN 104 may include a plurality of LANs at a plurality of sites connected via a dedicated line(s) or a VPN (virtual private network). The information devices 110 to 116 in the office 102 are connected to the device-security management server 140 installed separately from the office 102 via a public network 106 such as the Internet.

In the embodiment, the office 102 is, but not limited to, a site of a service user(s) receiving maintenance and management service for the information devices. In contrast thereto, the device-security management server 140 and the assessment-result providing server 160 are installed at a site, which is different from the service user's site, of a service provider providing the maintenance and management service for the information devices. Remotely connecting the information devices 110 to 116 to the device-security management server 140 via a network means, more specifically, connecting the information devices 110 to 116 and the device-security management server 140, which is installed separately from the information devices 110 to 116, over a network, e.g., the public network 106.

FIG. 1 exemplifies types of the information devices to be managed. Referring to FIG. 1, an MFP (multifunction peripheral), a laser printer, a projector, and a teleconference terminal are given as examples of the information devices 110, 112, 114, and 116, respectively. Note that the information device that can be the management target is not limited to those illustrated in FIG. 1 but can be any electronic device connected to the network. Examples of the electronic device include an image forming device, an image reading device, an image communication device, a video projector, a video display device, a teleconference terminal, an interactive whiteboard, a personal digital assistant, an image capture device, a vending machine, a medical device, a power supply device, an air-conditioning system, a metering device for gas, water, electricity, or the like, and network home appliances such as a refrigerator and a washing machine. Each of the assessment server 120, the device-security management server 140, and the assessment-result providing server 160 may typically be configured by a general-purpose computer such as a server computer.

In the office 102 illustrated in FIG. 1, an administrator's terminal 170 is connected to the LAN 104. The administrator's terminal 170 is a terminal to be operated by an administrator(s) of the office 102 to access the assessment-result providing server 160 via the public network 106 and view an assessment result. In the embodiment, it is assumed that the administrator's terminal 170 is installed in the office 102; however, a location of the administrator's terminal 150 is not limited thereto. The administrator's terminal 170 may typically be configured by a personal computer, a tablet computer, a smartphone, or the like.

It is desired to apply security management of a security level equivalent to that of a personal computer or a server computer to the management target information devices 110 to 116. However, there can be a case where one or more of the information devices 110 to 116 have a factor that makes security management troublesome for the administrator(s). Examples of the factor include security management items or menus different from those of a personal computer or a server computer, absence of a display device in the one or more of the information devices 110 to 116, and a small size of a display device even if the display device is provided. Furthermore, a large number of information devices can be arranged in an office. Accordingly, it is difficult to detect a security problem across the entire office if security settings are on a per-device basis. In particular, from a perspective of security management, a weakest security setting can cause a threat to the entire office. For this reason, a security management on a per-office basis is desired. Furthermore, in some type of the office 102, external information transmission of raw data, e.g., data about a device usage condition, is prohibited. There can also be cases, in which limitation is imposed by a domestic law or a regional law on transmitting data abroad or to the outside of a region.

In the device management system 100 according to the embodiment, the assessment server 120 described above is arranged in the LAN 104 in the same office 102 as the management target information devices 110 to 116. The management target information devices 110 to 116 provide reports about their own security setting states to the assessment server 120 via the LAN 104 at regular or irregular intervals. The assessment server 120 receives the reports from the information devices 110 to 116 and accumulates the reports. The assessment server 120 also assesses security setting contents of the information devices 110 to 116 based on the reports and generates an assessment result in accordance with a predetermined schedule. The assessment server 120 transmits only the generated assessment result, rather than both the reports acquired from the information devices 110 to 116 and the assessment result, externally to the device-security management server 140 via the public network 106. The device-security management server 140 outputs a security-assessment result report containing findings on the setting contents in the management area, in which the information devices are arranged, to the assessment-result providing server 160.

The assessment-result providing server 160 is configured to receive the security-assessment result report from the device-security management server 140, store the report, and wait for receiving a request to view the assessment result from the administrator's terminal 170. The assessment-result providing server 160 is configured to provide the security assessment result in response to a request to view the assessment result from the administrator's terminal 170. This makes it possible to assess the setting contents of the information devices in the management area and adapt to an environmental change in the management area where the information devices are installed. Furthermore, the report, which is raw data, about the security setting states is transmitted only to the assessment server 120 via the LAN 104, whereas only the processed assessment result is transmitted from the assessment server 120 externally to the device-security management server 140. Because raw data is not transmitted to the outside, it is possible to adapt to a situation where external transmission of raw data is prohibited or limited.

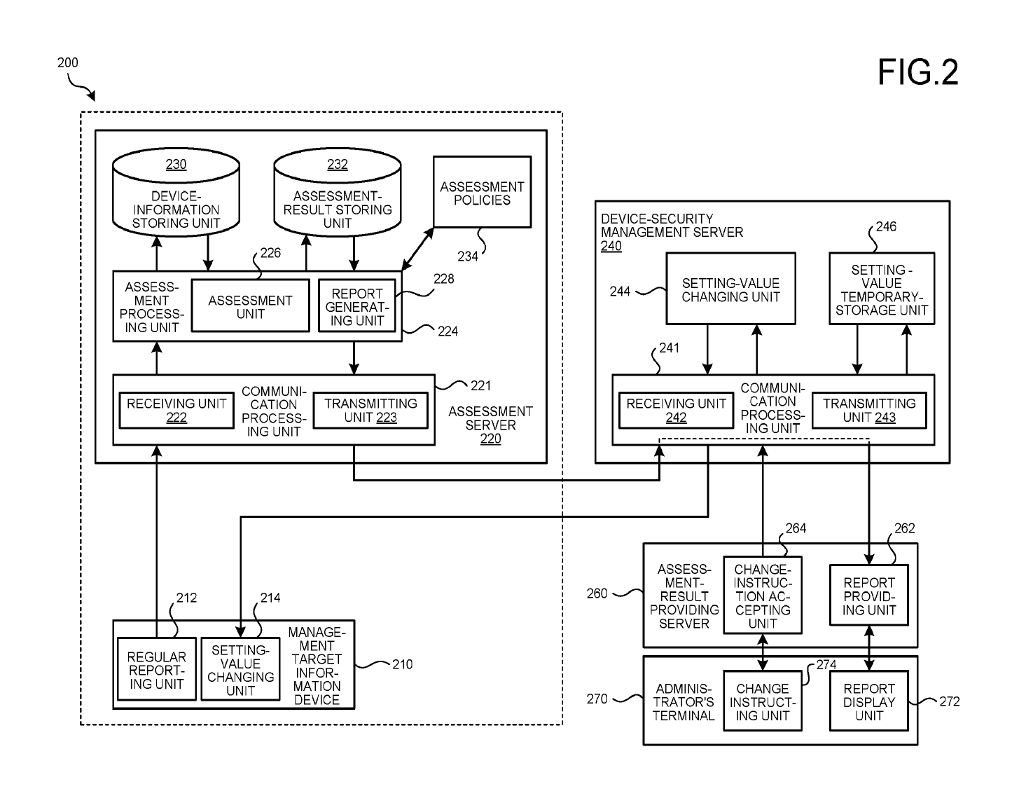

Security management function implemented by the device management system 100 according to the embodiment is described below with reference to FIG. 2. FIG. 2 is a functional block diagram illustrating a configuration of the device management system 100 according to the embodiment. FIG. 2 indicates flows of various types of information by arrows.

A functional block 200 on the device management system 100 includes a functional block 210 implemented on the management target information device 110, a functional block 220 implemented on the assessment server 120, a functional block 240 implemented on the device-security management server 140, a functional block 260 implemented on the assessment-result providing server 160, and a functional block 270 implemented on the administrator's terminal 170. Hereinafter, the MFP 110 is referred to as the management target information device 110 representing the information devices 110 to 116. As indicated by the dashed-line box, the functional block 210 of the management target device and the functional block 220 of the assessment server 120 are arranged in the LAN 104 on the service user's side. In the embodiment, it is assumed that the assessment server 120 is an apparatus different from the information device 110 to be managed. However, in other embodiment, the functional block of the assessment server 120 illustrated in FIG. 2 may be implemented on the functional block of any one of the information devices 110 to be managed.

The functional block 220 on the assessment server 120 includes a communication processing unit 221, an assessment processing unit 224, a device-information storing unit 230, an assessment-result storing unit 232, and assessment policies 234.

The communication processing unit 221 includes a communication interface for allowing the assessment server 120 to communicate with the external device-security management server 140 and with the management target information device 110. More specifically, the communication processing unit 221 includes a receiving unit 222 and a transmitting unit 223. In the embodiment, the receiving unit 222 functions as “acquisition unit” configured to acquire information about a security setting state of the information device 110 from the information device 110 via the LAN 104. In the embodiment, the transmitting unit 223 functions as “transmitting unit” configured to transmit an assessment result to the device-security management server 140 via the public network 106. Communication between the assessment server 120 and the device-security management server 140 is preferably carried out with and protected by encrypted communication such as SSL (secure sockets layer).

The assessment processing unit 224 receives a report about the security setting state from the management target information device 110 and, furthermore, assesses security setting contents of the management target information device 110 based on the report and generates an assessment result. The assessment processing unit 224 corresponds to “assessment processing unit” in the embodiment. More specifically, the assessment processing unit 224 includes n assessment unit 226 and a report generating unit 228.

The assessment unit 226 receives the report about the security setting state from the management target information device 110 and accumulates the report in the device-information storing unit 230. The assessment unit 226 reads out reports from the device-information storing unit 230 in accordance with a predetermined schedule and assesses security setting contents of each of the management target information devices 110 managed in the management area in which the assessment unit 226 is arranged, based on the report. Upon obtaining assessment results of the respective management target information devices 110, the assessment unit 226 stores the assessment results in the assessment-result storing unit 232. The assessment unit 226 corresponds to “assessment unit” in the embodiment.

The report generating unit 228 reads out security assessment results of the respective management target information devices 110 managed in the management area in which the report generating unit 228 is arranged, from the assessment-result storing unit 232. The report generating unit 228 generates a security-assessment result report containing findings on the setting contents on a per-management-area basis based on the read-out per-device security assessment results. The generated security-assessment result report is transmitted to the device-security management server 140 via the transmitting unit 223. The report is preferably processed such that a user that receives the report can view the report.

The per-management-area security-assessment result report is obtained by integrating the security assessment results of the plurality of information devices in the corresponding management area together. In a specific embodiment, as will be described in detail later, in the per-management-area security-assessment result report, a conformance state farthest, among the assessment results of the plurality of information devices, from a conformance level for a predetermined assessment item may be determined as an overall result. This is because a weakest security setting can cause a threat to the entire management area. The report generating unit 228 corresponds to “generation unit” in the embodiment.

The device-information storing unit 230 is a database, in which the report on the security setting state received by the receiving unit 222 from the information device 110 is stored and which manages the report by associating the report with a device identifier (hereinafter, “device ID”) for identifying the management target information device 110, from which the report is provided. The assessment-result storing unit 232 is a database, in which an assessment result of each information device and an assessment result of each management area generated by the assessment processing unit 224 are stored and which manages the results by associating each of the results with a management area identifier (hereinafter, “management area ID”) for managing the office 102 and a device ID for identifying the assessed management target information device 110.

Each of the assessment policies 234 is a policy to be referred to each time when an assessment is conducted on the per-management target information device basis and on the per-management-area basis and defines, for each assessment item, what setting contents achieve a predetermined security conformance level. The assessment policy 234 can contain information associating a conformance state with each of possible setting options for each predetermined assessment item. The conformance state indicates whether or not the setting option achieves the conformance level and, if the setting option achieves the conformance level, to what extent the setting option achieves the conformance level. The assessment policy 234 may further contain an integration method as to how to integrate assessment results of a plurality of management target information devices in the management area.

For the purpose of security management, operating policy varies in severity among management areas. Accordingly, a preferred embodiment may be configured such that the assessment policies 234 are managed for each of management areas of service users; each of the assessment policies 234 contains a uniquely-created custom policy or a predetermined policy associated with a plurality of levels (e.g., “high”, “medium”, and “low”). The assessment policy 234 may be appropriately edited or selected by a user to adapt to characteristics of the management area.

The functional block 240 on the device-security management server 140 includes a communication processing unit 241, a setting-value changing unit 244, and a setting-value temporary-storage unit 246.

The communication processing unit 241 includes a communication interface for enabling the device-security management server 140 to externally communicate with the assessment server 120, the assessment-result providing server 160, and the management target information device 110. More specifically, the communication processing unit 241 includes a receiving unit 242 and a transmitting unit 243. In the embodiment, the receiving unit 242 functions as “receiving unit” configured to receive an assessment result from the assessment server 120. In the embodiment, the transmitting unit 243 functions as “output unit” configured to output an obtained security-assessment result report to the assessment-result providing server 160.

In a preferred embodiment, the receiving unit 242 of the communication processing unit 241 is configured to further receive an instruction to change a setting from a user based on the assessment result report. The setting-value changing unit 244 performs setting-value check and format conversion for each of the devices based on the received instruction to change the setting, and causes the transmitting unit 243 of the communication processing unit 241 to transmit a request to change the setting based on the instruction to the information device, which is requested to change the setting. The value check denotes a process of inspecting whether or not a received post-change setting value is a value selectable to the information device, which is requested to change the setting. The format conversion denotes a process of conversion into a format interpretable by the information device, which is requested to change the setting.

The setting-value temporary-storage unit 246 is a storage unit, in which the request to change the setting, which is based on the instruction to change the setting, is temporarily stored. In the embodiment, the device-security management server 140 does not initiate communication to the information device 110 in the office 102. Instead, after changing a setting is instructed, a request to change the setting is transmitted to an information device, which is requested to change the setting, at the timing when communication is first initiated by the information device. In short, the embodiment is configured such that communication is initiated by the information device 110. The information device 110 periodically initiates communication, such as polling, to the device-security management server 140. The request to change the setting is transmitted to the information device 110 together with a response to the communication initiated by the information device 110.

The functional block 210 on the management target information device 110 includes a regular reporting unit 212 and a setting-value changing unit 214. In the embodiment, the regular reporting unit 212 regularly transmits a report about security setting state of the information device 110 to the assessment server 120 over the LAN 104. The setting-value changing unit 214 receives a request to change a setting from the device-security management server 140 via the public network 106 and performs a process of changing a setting value of a setting item involved in the request. Communication between the information device 110 and the device-security management server 140 is preferably carried out with and protected by encrypted communication such as SSL.

The functional block 260 on the assessment-result providing server 160 includes a report providing unit 262 and a change-instruction accepting unit 264. The functional block 270 on the administrator's terminal 170 includes a report display unit 272 and a change instructing unit 274.

In a specific embodiment, the assessment-result providing server 160 has a web server function. The report providing unit 262 and the change-instruction accepting unit 264 are provided as the web server function. In the specific embodiment, the administrator's terminal 170 includes a web client such as a web browser; the report display unit 272 and the change instructing unit 274 are implemented on the web client based on HTML (hypertext markup language) data acquired from the assessment-result providing server 160.

The report display unit 272 of the administrator's terminal 170 requests an assessment result report from the assessment-result providing server 160 and, upon receiving the report from the assessment-result providing server 160, displays the report on a display device such as a display. The report providing unit 262 of the assessment-result providing server 160 performs login authentication of the administrator's terminal 170. The report providing unit 262 transmits, in response to the request for the report from the administrator's terminal 170, an assessment result report on a management area, where the login-authenticated user is registered as an administrator, to allow the user to view the assessment result report. The report display unit 272 corresponds to “viewer unit” in the embodiment.

A preferred embodiment may be configured such that the change instructing unit 274 of the administrator's terminal 170 can instruct the assessment-result providing server 160 to change a setting in response to an operation made by the user based on the assessment result report. The change-instruction accepting unit 264 of the assessment-result providing server 160 can accept the instruction to change the setting from the administrator's terminal 170 and, in response thereto, transmit the user's instruction to change the setting to the device-security management server 140. Upon receiving the instruction to change the setting, the device-security management server 140 operates as described earlier. That is, the setting-value changing unit 244 performs processing such as format conversion based on the received instruction to change the setting and causes a request to change the setting to be temporarily stored in the setting-value temporary-storage unit 246. Thereafter, the transmitting unit 243 of the communication processing unit 241 transmits the request to change the setting to the information device, which is requested to change the setting.

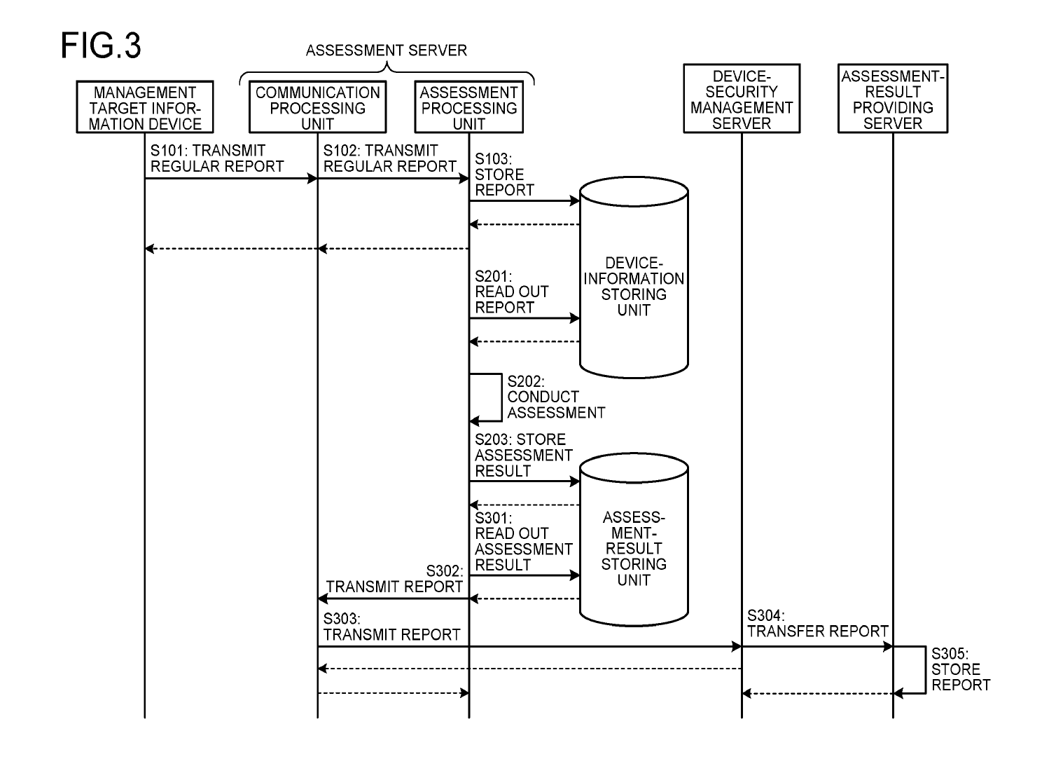

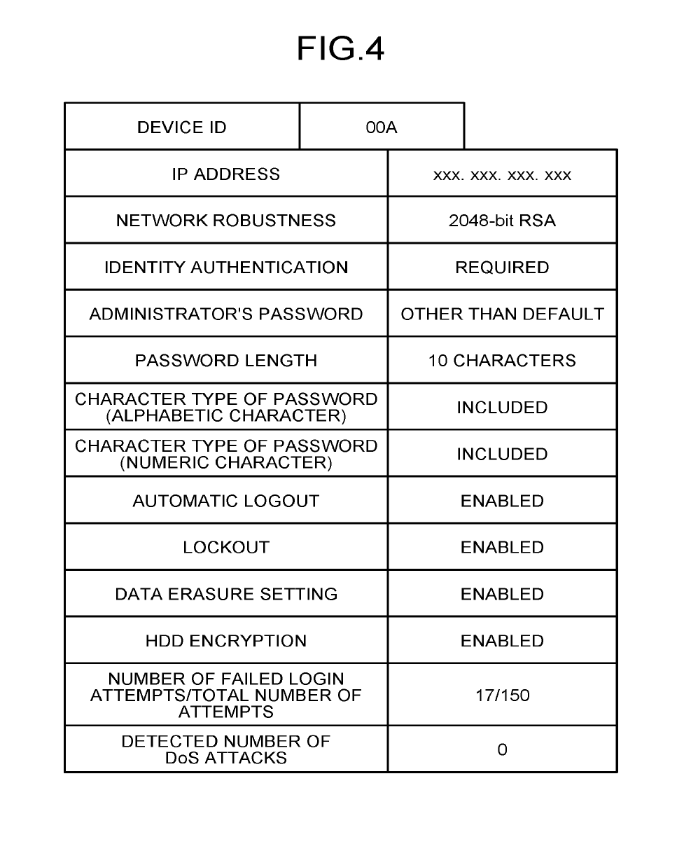

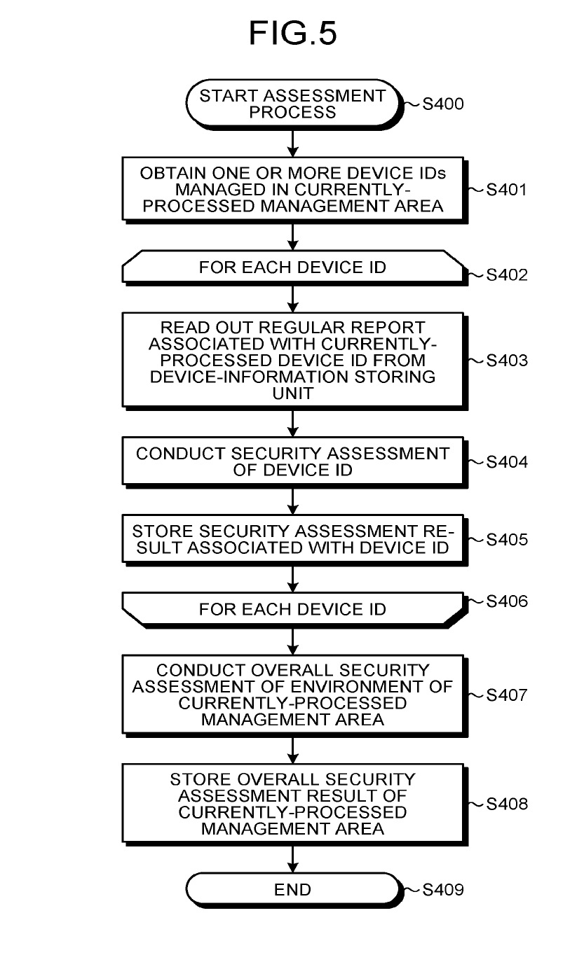

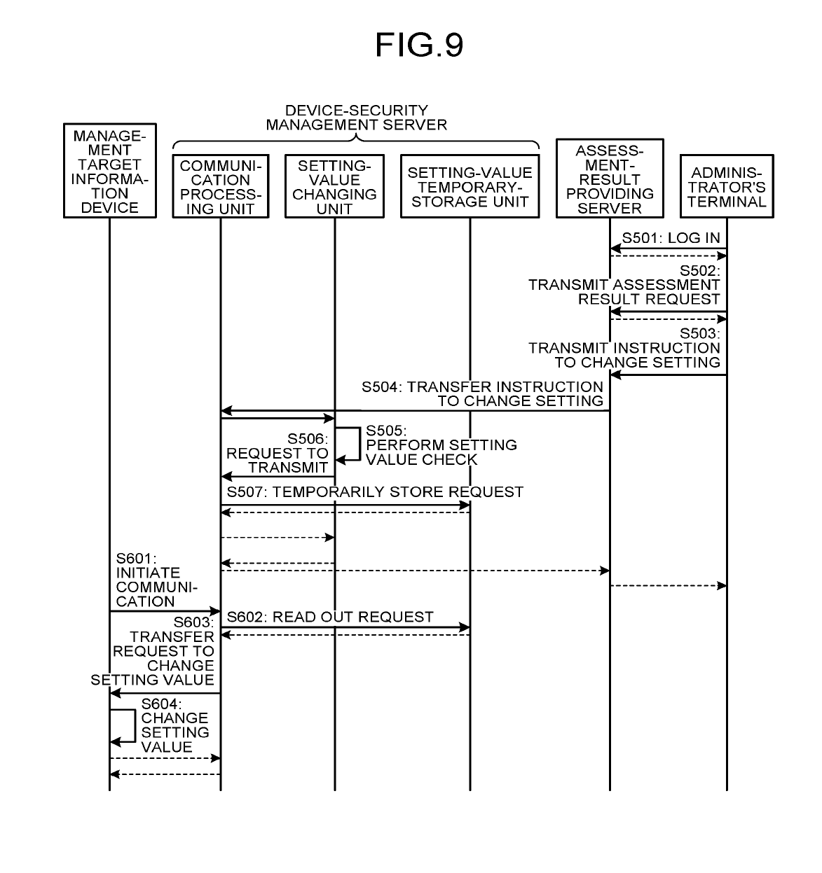

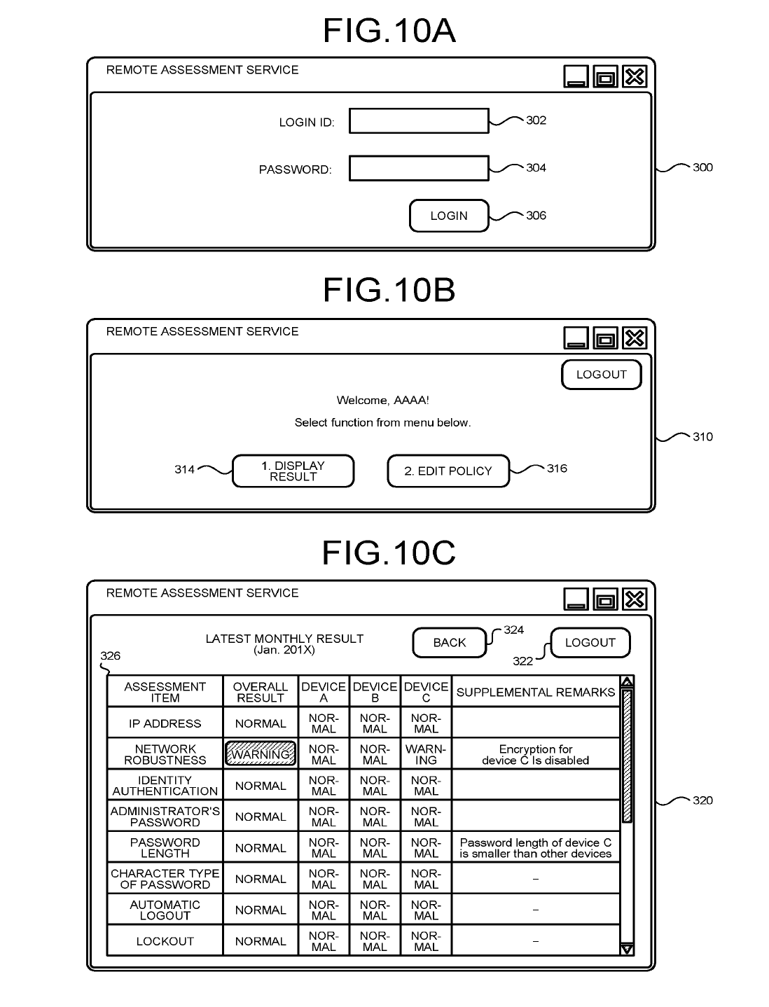

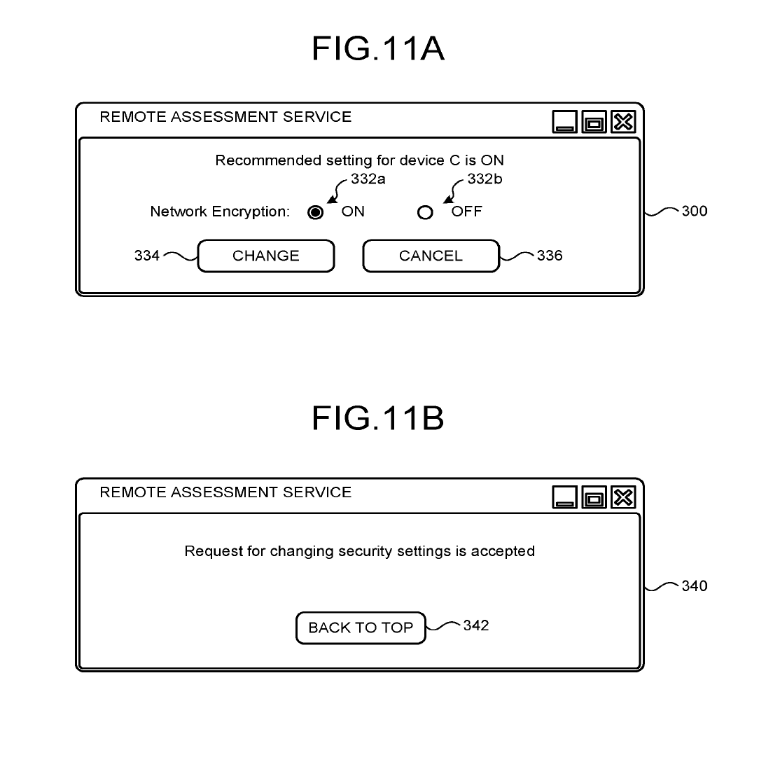

Processes to be performed by the device management system 100 according to the embodiment to implement the security management function are described more specifically below with reference to FIGS. 3 to 11B. FIGS. 3 and 9 are sequence diagrams illustrating security management to be performed by the device management system 100 according to the embodiment. FIG. 3 illustrates processing from regular reporting from the management target information device 110 to storing a report in the assessment-result providing server 160. FIG. 9 illustrates processing from viewing an assessment result using the administrator's terminal 170 to changing a setting. FIGS. 4 and 6A to 8 are diagrams illustrating data structures of various data used by the device management system 100 according to the embodiment. FIG. 5 is a flowchart illustrating an assessment process to be performed on the per-information-device basis and on the per-management-area basis by the assessment processing unit according to a specific embodiment. FIGS. 10A to 11B are diagrams illustrating graphical user interfaces (GUIs) to be displayed on the administrator's terminal 170 of the embodiment.

The report receiving process illustrated in FIG. 3 is started at S101 by a one of the management target information devices 110 upon arrival of scheduled regular reporting time. At S101, the management target information device 110 causes the regular reporting unit 212 to generate report data based on the security setting state set in the information device 110 and transmits a regular report to the assessment server 120. At S102, the communication processing unit 221 of the assessment server 120 transmits the regular report received from the management target information device 110 to the assessment processing unit 224. At S103, the assessment processing unit 224 stores the received regular report in the device-information storing unit 230. Then, the process ends.

FIG. 3 also illustrates the assessment process. The assessment process illustrated in FIG. 3 starts at S201 in response to occurrence of an event, which is determined in advance as an event triggering the start of the assessment process. The assessment process can be performed regularly as is the regular reporting and may be appropriately scheduled depending on desired assessment frequency. For instance, the assessment process may be performed at desired intervals such as once an hour, day, week, or month. At S201, the assessment processing unit 224 reads out report data from the device-information storing unit 230.

FIG. 4 is a diagram illustrating a data structure of report data accumulated in the device-information storing unit 230 according to the embodiment. As illustrated in FIG. 4, the report data holds various setting options associated with a device ID. In the example illustrated in FIG. 4, the setting options include, but not limited to, a communication address (IP address), network robustness (communication encryption method), presence or absence of identity authentication, whether or not administrator's password is its initial value (default password), the length of the administrator's password, mixture state of character types included in the administrator's password (including whether or not the password includes an alphabetic character and whether or not the password includes a numeric character), presence or absence of forced logout setting (automatic logout function), presence or absence of a maximum number of failed password entries (lockout function), presence or absence of data erasure setting, and presence or absence of auxiliary storage device encryption (HDD encryption). Unless these security settings are appropriately set, an influence can be directly exerted on security of the management target information device 110 and, furthermore, across the management area. Accordingly, in the embodiment, these pieces of information are collected for assessment.

The forced logout setting (the automatic logout function) described above is a setting of enabling or disabling a function of forcefully logging out if a predetermined amount of idle time has elapsed since last login. The maximum number of failed password entries (the lockout function) is a setting of enabling or disabling a function of forcefully locking out login attempts if password entry for an account fails a predetermined number of times. The data erasure setting is a setting as to whether or not to completely erase data using a predetermined method. There are various data erasure methods including overwriting with zeros, overwriting with random patterns, and NSA method. Accordingly, the setting options may include designation of such a data erasure method.

As illustrated in FIG. 4, the report data may further include a dynamic security counter value(s) such as a login failure rate (the number of failed login attempts/total number of login attempts) and presence or absence of a network attack (DoS (denial of service) attack detection). Such security counters, in order to suggest a possibility of an unauthorized attempt to access the management target information device 110, collects these values for assessment of this. Additionally collecting such security counter values as those described above makes it possible to maintain a security level equal to or higher than that maintained only by assessing security setting contents.

Referring back to FIG. 3, at S202, the assessment processing unit 224 conducts security assessment on the per-management target information device basis and on the per-management-area basis based on the report data about each of the management target information devices 110 read out from the device-information storing unit 230. At S203, the assessment processing unit 224 stores results of the security assessment in the assessment-result storing unit 232. Then, the process ends.

FIG. 5 illustrates in detail the assessment process from S201 to S203 illustrated in FIG. 3. The process illustrated in FIG. 5 starts at S400 in accordance with the predetermined schedule.

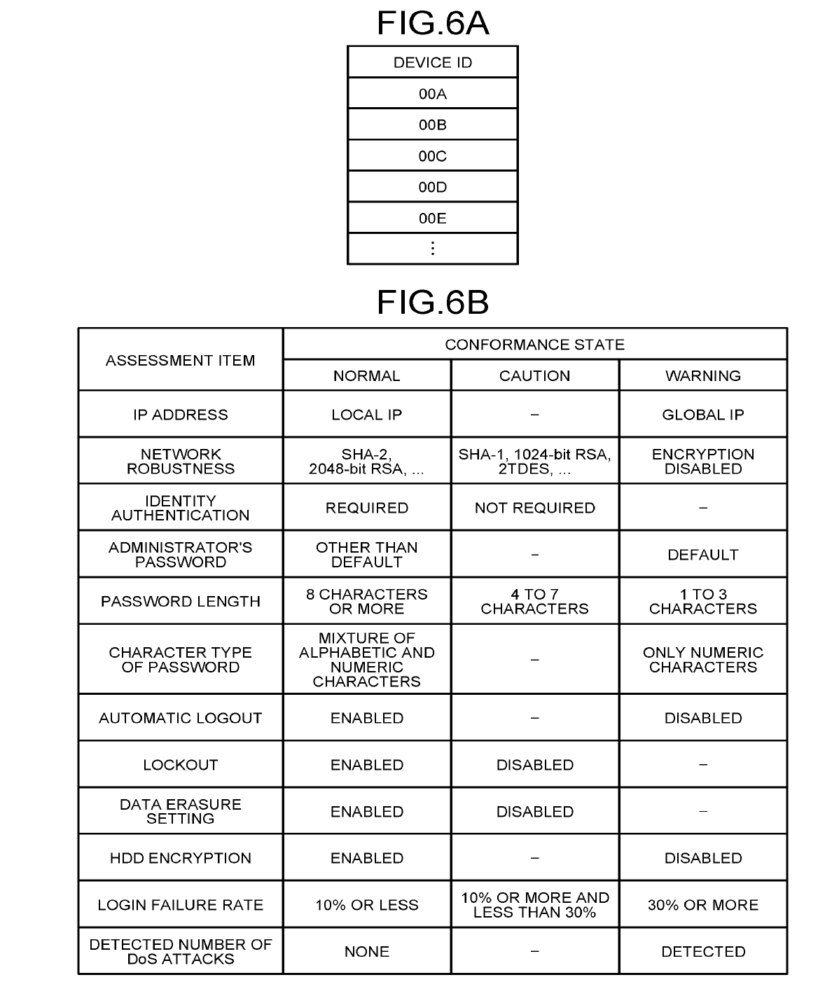

The assessment server 120 manages all the to-be-managed information devices in the LAN 104 where the assessment server 120 resides. Each of the information devices is registered in advance. FIG. 6A illustrates a data structure of management data for managing the management target information device in the management area, which is the office. At S401, the assessment processing unit 224 reads out all device IDs associated with a currently-processed management area from the management data illustrated in FIG. 6A.

The assessment processing unit 224 repeats the loop from S402 to S406 so that the process from S403 to S405 is performed for each of the read-out one or more device IDs associated with the management area. At S403, the assessment processing unit 224 reads out a latest regular report associated with a currently-processed device ID from the device-information storing unit 230. At S404, the assessment processing unit 224 conducts security assessment based on the regular report associated with the device ID in accordance with a corresponding one of the assessment policies 234. At S405, the assessment processing unit 224 stores a result of the security assessment corresponding to the device ID in the assessment-result storing unit 232.

FIG. 6B is a diagram illustrating a data structure of an assessment policy to be referred to in the embodiment. The assessment policy illustrated in FIG. 6B associates each assessment item with setting contents corresponding to predetermined conformance states. As an example of the conformance states, three states of “normal”, “caution”, and “warning” are given in the embodiment illustrated in FIG. 6B. However, the conformance states are not limited thereto, and the number of the conformance states may be two or, alternatively, four or more with finer granularity.

The assessment policy illustrated in FIG. 6B is described below. With reference to an assessment item “IP address”, when a setting item “IP address” in report data is a local IP address, it is determined that the “IP address” is in the “normal” state; while if the same is a global IP address, it is determined that the “IP address” is in the “warning” state.

The assessment policy illustrated in FIG. 6B is only an example and may include other assessment items. Furthermore, various severities may be required by the assessment policy. For instance, although a global IP address is determined as the “warning” state according to the assessment policy illustrated in FIG. 6B, the assessment policy may be configured so as to determine a global IP address as the “caution” state.

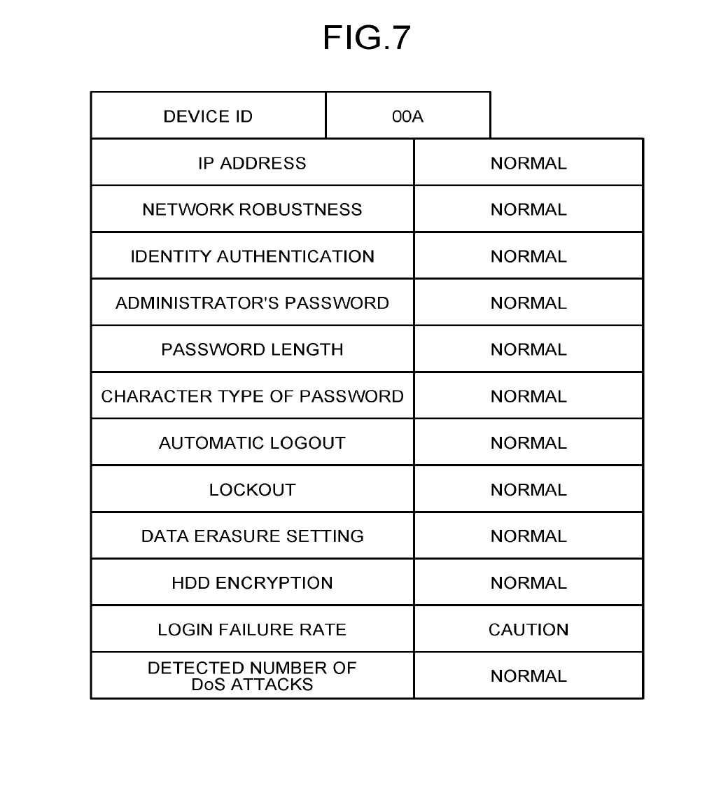

FIG. 7 is a diagram illustrating a data structure of assessment result data stored in the assessment-result storing unit 232 for each information device according to the embodiment. The assessment result data illustrated in FIG. 7 is managed in association with a device ID and contains assessment items and, for each of the assessment items, a conformance state (“normal”, “caution”, or “warning”) obtained as an assessment result for the assessment item.

Referring back to FIG. 5, when the assessment process for each of the read-out one or more device IDs associated with the currently-processed management area is completed, processing exits the loop from S402 to S406 and proceeds to S407. At S407, the assessment processing unit 224 reads out assessment result data about the information device(s) identified by the one or more device IDs managed in the management area, which is currently processed, and conducts overall security assessment of an environment of the management area in accordance with a corresponding one of the assessment policies 234. At S408, the assessment processing unit 224 stores a result of the overall security assessment of the management area in the assessment-result storing unit 232. At S409, the process ends.

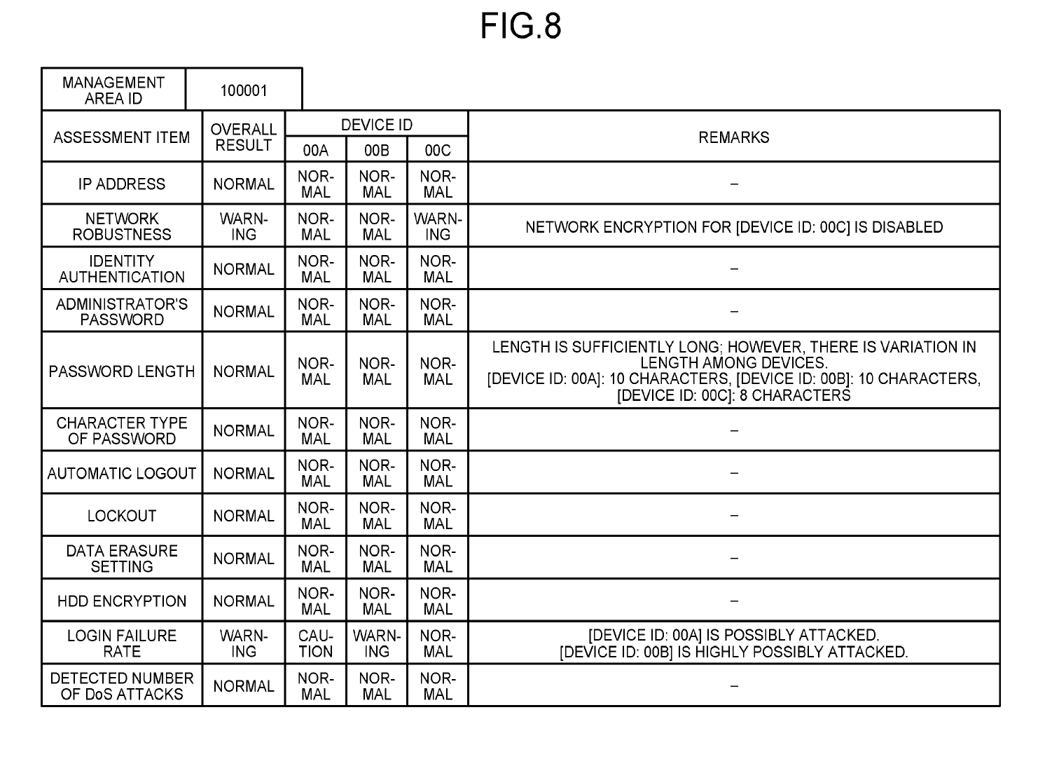

FIG. 8 is a diagram illustrating a data structure of security-assessment result data on the management area stored in the assessment-result storing unit 232 according to the embodiment. The assessment result data illustrated in FIG. 8 contains the assessment items and, for each of the assessment items, an overall result, conformance states of respective management target information devices, and a remarks column. The assessment result data illustrated in FIG. 8 is associated with the management area ID of the office where the assessment server 120 resides.

The overall security assessment result of the management area illustrated in FIG. 8 is obtained by integrating security assessment results of the plurality of information devices 110 in the management area together. Under an assessment policy of a preferable embodiment, a conformance state farthest, among conformance states of the assessment results of the plurality of information devices, from a conformance level for a predetermined assessment item is determined as an overall assessment result. In short, it is determined that overall security environment of the management area is insufficient if there is even one security hole in any one of the management target information devices in the management area.

The security assessment result of the management area can contain findings on the security setting contents. The security assessment result can further include findings of presence of a security threat, findings of an item where security does not conform to the policy, and findings of a mismatch of security setting items between information devices.

For instance, with reference to the assessment item “network robustness” of the security-assessment result data illustrated in FIG. 8, two information devices (hereinafter, the information device whose device ID is 00A is referred to as “device A”; the information device whose device ID is 00B is referred to as “device B”) are in the “normal” state, but the other one information device (hereinafter, the information device whose device ID is 00C is referred to as “device C”) is in the “warning” state. Accordingly, the overall result is the “warning” state, which is farthest from the conformance level. Various supplemental descriptions are given in the remarks column. For example, the remarks column of the assessment item “network robustness” contains findings that network encryption for the device C, which is in the “warning” state, is disabled.

With reference to the assessment item “password length”, the overall result is the “normal” state because each of the three information devices has a sufficient password length. However, whereas the password length of the device A and the device B is 10 characters, that of the device C is 8 characters. Accordingly, a supplemental remark about this variation in the password length is given for the assessment policy. With reference to the assessment item “login failure rate”, although the device C is in the “normal” state, the device A is in the “caution” state, and the device B is in the “warning” state. Accordingly, the overall security assessment result is the “warning” state, which is farthest from the conformance level.

Referring back to FIG. 3, FIG. 3 also illustrates an assessment-result reporting process. The assessment-result reporting process illustrated in FIG. 3 starts at S301 in response to occurrence of an event, which is determined in advance as an event triggering the start of the reporting process. The assessment-result reporting process may be performed each time a report on the management area is generated.

At S301, the assessment processing unit 224 reads out integrated assessment-result data about a currently-processed management area from the assessment-result storing unit 232. At S302, the assessment processing unit 224 instructs the communication processing unit 221 to transmit the assessment result data on the management area read out from the assessment-result storing unit 232. At S303, the communication processing unit 221 transmits the assessment result data passed from the assessment processing unit 224 to the device-security management server 140 using the transmitting unit 223. The device-security management server 140 receives the assessment result data at the receiving unit 242. At S304, the communication processing unit 241 of the device-security management server 140 transfers the assessment result data received from the assessment server 120 to the assessment-result providing server 160 using the transmitting unit 243. The assessment-result providing server 160 receives the assessment result data. At S305, the assessment-result providing server 160 stores the received assessment result data. Then, the process ends. The assessment-result providing server 160 manages the assessment result data in association with the managed area ID.

The processing from viewing the assessment result using the administrator's terminal 170 to changing a setting is described below with reference to FIG. 9. The viewing process illustrated in FIG. 9 starts at S501 in response to a user's instruction given to the administrator's terminal 170 to log in. At S501, login to the assessment-result providing server 160 is performed by the administrator's terminal 170.

FIG. 10A illustrates an example of a login screen 300. Referring to the login screen 300 illustrated in FIG. 10A, when a user enters a login ID and a password of an administrator of the management area to text boxes 302 and 304, respectively, and clicks a “LOGIN” button 306, a login request is transmitted from the administrator's terminal 170 to the assessment-result providing server 160, and login authentication is performed.

At S502, the administrator's terminal 170 transmits an assessment result request to the assessment-result providing server 160 and receives an assessment result. FIG. 10B illustrates an example of a menu screen 310 that appears after login authentication. The menu screen 310 contains a “DISPLAY RESULT” button 314 and an “EDIT POLICY” button 316. Clicking the “DISPLAY RESULT” button 314 on this screen causes the assessment result request to be transmitted from the administrator's terminal 170 to the assessment-result providing server 160.

FIG. 10C illustrates an example of an assessment-result display screen 320. The assessment-result display screen 320 contains a result table 326 presenting a per-management-area assessment result. The user can know of the findings about security setting states in the management area by viewing the assessment-result display screen 320. The assessment-result display screen 320 illustrated in FIG. 10C corresponds to the per-management-area security-assessment-result data illustrated in FIG. 8 and contains per-management-area overall results and per-information-device assessment results. In the embodiment, the result table 326 contains a “WARNING” button in a cell where the overall result is in the “warning” state.

FIG. 11A illustrates an example of a setting changing screen 330. Clicking the “WARNING” button on the assessment-result display screen 320 illustrated in FIG. 10C causes the setting changing screen 330 illustrated in FIG. 11A to be displayed. The setting changing screen 330 contains radio buttons 332 for specifying whether to enable or disable the setting item “network robustness”, a “CHANGE” button 334 for accepting a change instruction according to the current contents, and a “CANCEL” button 336 for accepting an instruction to cancel a setting change.

At S503, the administrator's terminal 170 transmits an instruction to change a setting to the assessment-result providing server 160. When, on the setting changing screen 330 illustrated in FIG. 11A, a desired setting change is selected using the radio buttons 332 and the “CHANGE” button 334 is clicked, an instruction to change the setting is transmitted from the administrator's terminal 170 to the assessment-result providing server 160.

Upon receiving the instruction to change the setting, the assessment-result providing server 160 transfers the instruction to change the setting to the device-security management server 140 at S504. The setting-value changing unit 244 accepts the instruction to change the setting via the communication processing unit 241 and, at S505, performs setting-value check and format conversion. At S506, the setting-value changing unit 244 instructs the communication processing unit 241 to transmit a request to change the setting. At S507, the communication processing unit 241 causes the setting-value temporary-storage unit 246 to temporarily store the request to change the setting. Then, the process is temporarily held. A response is returned to the administrator's terminal 170, and a result to the instruction to change the setting is displayed. FIG. 11B illustrates an example of a settings-change completion screen 340 where a message indicating that the instruction to change the setting is accepted is displayed. If a “BACK TO TOP” button 342 is clicked, the menu screen 310 illustrated in FIG. 10B is displayed.

In response to this, actual change of a setting value is started by the management target information device 110. At S601, the management target information device 110 initiates communication, such as polling, to the device-security management server 140. Upon receiving the communication, the communication processing unit 241 of the device-security management server 140 reads out the temporarily-stored request to change the setting from the setting-value temporary-storage unit 246 at S602. At S603, the communication processing unit 241 transmits the request to change the setting, together with a response to the communication, to the management target information device 110 using the transmitting unit 223. At S604, the management target information device 110 changes the setting. Then, the process ends.

In the embodiment, assessment results are described as being provided as a web page; however, the form of presenting the assessment results is not limited thereto. For instance, the assessment results may be provided as a spread sheet. In this case, a cell with the “warning” state may be hyperlinked to a URL (uniform resource locator) for changing e a corresponding setting value.

A summary of a procedure for a service user to access the assessment-result providing server 160, check an assessment result, and change a setting based on the assessment result using the assessment-result providing server 160 is given below.

First, the service user accesses the assessment-result providing server 160 by utilizing, for example, a web browser from the administrator's terminal 170. When the user is login-authenticated via the browser, the assessment selection menu illustrated in FIG. 10B is displayed. When a menu is selected, the assessment-result display screen illustrated in FIG. 10C is displayed. If the “WARNING” button in the table is clicked, such a related setting menu as that illustrated in FIG. 11A is displayed. On this menu, the service user can click a “CHANGE” button to change a specific setting value on the web browser. Because the device-security management server 140 and the assessment-result providing server 160 are connected to each other via a network, a request to change the setting is fed to the device-security management server 140. The setting value involved in the change is temporarily stored in the device-security management server 140. At a next communication with the information device 110, the setting value is transmitted to the information device via the public network 106 as the request to change the setting. Eventually, the setting value is changed.

In the embodiment described above, a security assessment result is reported as a report. However, in a further embodiment, the assessment result may contain a suggestion for correcting a setting value, so that if automatic correction of a security setting item, for which the suggestion is given, is permitted by an administrator of the management area, the device-security management server 140 can automatically correct the setting value.

In the embodiment described above, processing from the regular reporting to the per-management-area assessment process, rather than from the regular reporting through the report storing, of the security management is performed by the assessment server 120; the assessment server 120 transmits a result of the per-management-area assessment process to the device-security management server 140. However, from the viewpoint of avoiding external information transmission of raw data, e.g., data about a device usage condition, the following configuration may be adopted. That is, report data, which is raw data, is processed into a primary assessment result not containing detailed setting information, which is directly acquired from an information device and contained in the raw data. Thereafter, the primary assessment result is transmitted to the device-security management server 140, thereby delegating, to the device-security management server 140, a remaining part of the assessment process including generating a secondary assessment result from the primary assessment result.

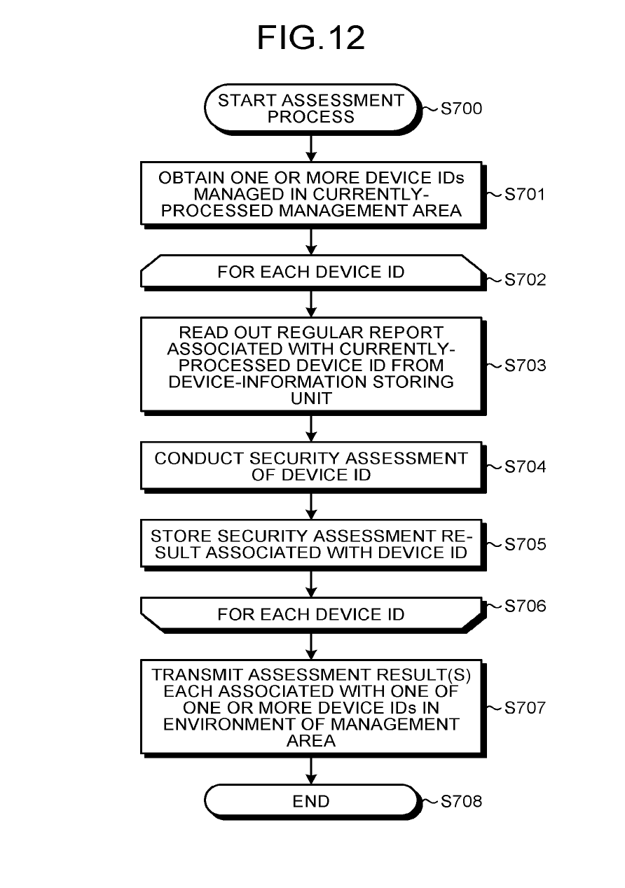

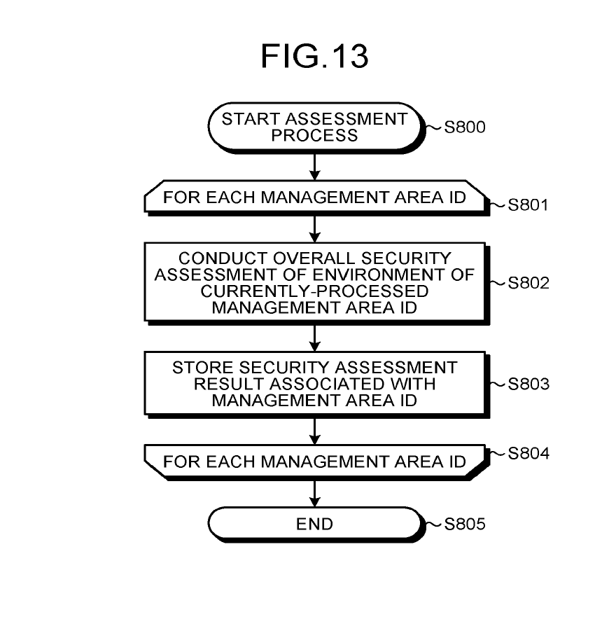

A device management system according to a further embodiment, in which the assessment process is partially delegated to the device-security management server 140, is described below with reference to FIGS. 12 and 13. Although details of functional blocks of the device management system according to the further embodiment are not described below, the device management system may have a configuration, in which the report generating unit 228 of the assessment processing unit 224 of the assessment server 120 illustrated in FIG. 2 is implemented on the device-security management server 140.

FIG. 12 is a flowchart illustrating an assessment process to be performed for each information device by the assessment server 120 according to the embodiment. FIG. 13 is a flowchart illustrating an assessment process to be performed for each management area by the device-security management server 140 according to the embodiment. The process illustrated in FIG. 12 is partly identical to the process illustrated in FIG. 5 and therefore what makes the process illustrated in FIG. 12 different from that illustrated in FIG. 5 is mainly described below.

The process illustrated in FIG. 12 starts at S700 in accordance with a predetermined schedule as does the process illustrated in FIG. 5. At S701, the assessment processing unit 224 reads out all device IDs managed in a currently-processed management area.

The assessment processing unit 224 repeats the loop from S702 to S706 so that the process from S703 to S705 is performed for each of the read-out one or more device IDs. At S703, the assessment processing unit 224 reads out a latest regular report associated with a currently-processed device ID from the device-information storing unit 230. At S704, the assessment processing unit 224 conducts security assessment based on the regular report associated with the device ID in accordance with a corresponding one of the assessment policies 234. At S705, the assessment processing unit 224 stores a result of the security assessment corresponding to the device ID in the assessment-result storing unit 232.

When the assessment process is completed for each of the read-out one or more device IDs associated with a currently-processed management area ID, processing exits the loop from S702 to S706 and proceeds to S707. At S207, the assessment processing unit 224 reads out assessment result data about each of the information device(s) identified by the one or more device IDs managed in the management area and transmits the security assessment results of each device to the device-security management server 140. At S708, the process ends.

The process illustrated in FIG. 13 starts at S800 in accordance with a predetermined schedule. The device-security management server 140 repeats the loop from S801 to S804 so that the process from S802 to S803 is performed for each of the management area IDs managed by the device-security management server 140. The device-security management server 140 manages all the to-be-managed management areas. The information devices are registered in advance in association with a corresponding management area.

At S802, the device-security management server 140 reads out assessment result data about the information devices identified by the one or more device IDs associated with the currently-processed management area ID and conducts overall security assessment of an environment of the management area ID in accordance with a corresponding one of the assessment policies 234. At S803, the device-security management server 140 stores a result of the overall security assessment associated with the management area ID.

If the process for each of the management areas ID managed by the device-security management server 140 is completed, processing exits the loop from S801 to S804 and proceeds to S805, where the process ends.

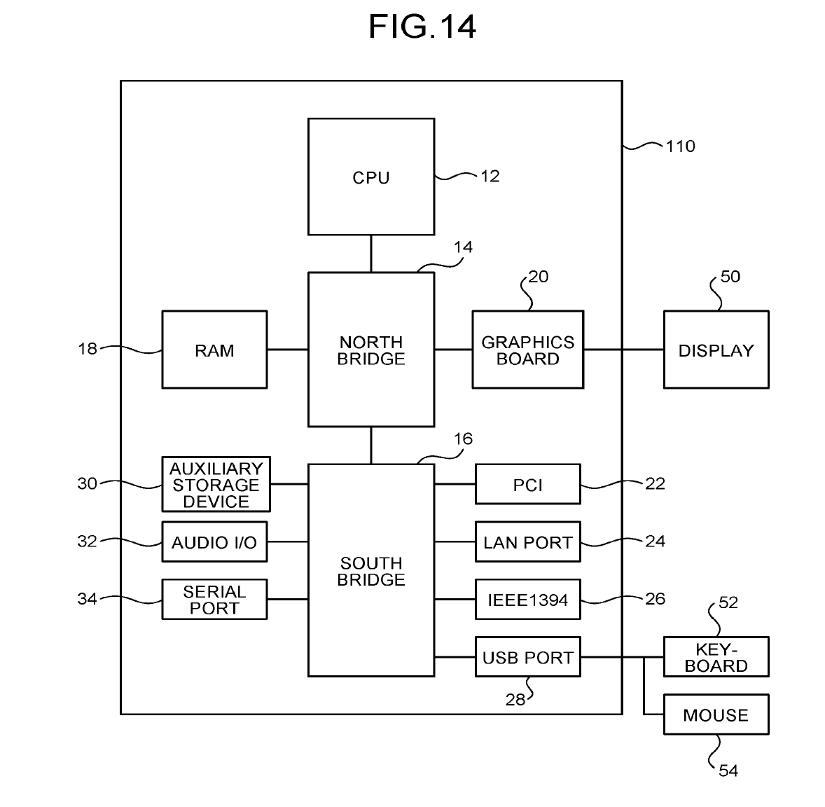

A hardware configuration of the assessment server 120 according to the present embodiments is described below with reference to FIG. 14. FIG. 14 is a diagram illustrating a hardware configuration of the assessment server 120 according to the present embodiments. The assessment server 120 according to the present embodiments is implemented as a general-purpose computer such as a desktop personal computer or a workstation. The assessment server 120 illustrated in FIG. 14 includes a single-core or multi-core CPU (central processing unit) 12, a north bridge 14 for connecting between the CPU 12 and a memory, and a south bridge 16 connected to the north bridge 14 via a dedicated bus or a PCI bus to handle connection with I/O (input/output) via a PCI bus, USB (universal serial bus), and the like.

A RAM (random access memory) 18, which provides a working area for the CPU 12, and a graphics board 20, which outputs video signals, are connected to the north bridge 14. The graphics board 20 is connected to a display 50 via a video output interface.

A PCI (peripheral component interconnect) 22, a LAN port 24, an IEEE (the Institute of Electrical and Electronics Engineers) 1394, an USB port 28, an auxiliary storage device 30 such as an HDD (hard disk drive) or an SSD (solid state drive), an audio I/O 32, and a serial port 34 are connected to the south bridge 16. The auxiliary storage device 30 stores OS (operating system) for controlling the computer, control programs for implementing the functional units described above, various system information, and various setting information. The LAN port 24 is an interface device for connecting the assessment server 120 to the LAN 104.

An input device such as a keyboard 52 and a mouse 54 may be connected to the USB port 28. The USB port 28 can provide a user interface for accepting various instructions entered by an operator of the assessment server 120.

The assessment server 120 according to the present embodiments implements the functional units and processes described above by reading out the control programs from the auxiliary storage device 30 and loading the programs in the working area provided by the RAM 18 under control of the CPU 12.

Although the assessment server 120 has been described above with reference to FIG. 14, each of the device-security management server 140, the assessment-result providing server 160, and the administrator's terminal 170 may be implemented in a similar hardware configuration. Although detailed description of the MFP 110, the laser printer 112, the projector 114, and the teleconference terminal 116 are omitted, they may be configured to include a CPU, a RAM, a network interface, and the like in a similar manner.

According to the present embodiments described above, an information management apparatus, an information management system, an information processing method, and an information device with capability of assessing setting contents of one or more information devices in a management area where the information device(s) is installed without transmitting information about the setting state(s) of the information device(s) acquired from the information device(s) to the outside of a network, to which the information device(s) is connected, and adapting to an environmental change in the management area.

In the present embodiments, security setting states of the management target information devices 110 to 116 are regularly assessed by the assessment server 120, to which the information devices 110 to 116 are connected via the LAN 104. Results of the security assessment are transferred to the device-security management server 140. The security assessment results are integrated on a per-management-area basis and provided to a user. Accordingly, it becomes possible to assess setting contents of one or more information devices in a management area where the information device(s) is installed and adapt to an environmental change in the management area.

Furthermore, reports, which are raw data, about the security setting states are transmitted only to the assessment server 120 via the LAN 104; only a processed assessment result is transmitted from the assessment server 120 to the device-security management server 140, which is outside an environment where the information devices are installed. Because raw data is not transmitted to the outside, it is possible to adapt to a situation, in which external transmission of raw data is prohibited or limited.

The functional units can be implemented in computer-executable program instructions described in a legacy programming language or an object-oriented programming language such as assembly language, C, C++, C#, or Java (registered trademark), and can be distributed by being stored in a device-readable recording medium such as a ROM (read only memory), an EEPROM (electrically erasable/programmable read only memory), an EPROM (erasable programmable read-only memory), a flash memory, a flexible disk, a CD-ROM (compact disc read-only memory), a CD-RW (compact disc-rewritable), a DVD-ROM, a DVD-RAM, a DVD-RW, a blue-ray disk, an SD (secure digital) card, or an MO (magneto optical) or via a telecommunication line.

According to an aspect of the present invention, it is possible to assess setting contents of an information device(s) in a management area where the information device(s) is installed, without transmitting information about the setting state(s) of the information device(s) acquired from the information device(s) to the outside of a network, to which the information device(s) is connected, and adapt to an environmental change in the management area.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information assessment system comprising:
an information management apparatus; and
an information assessment apparatus connected to at least one information device via a first network and connected to the information management apparatus via a second network,
the information assessment apparatus including:
an acquisition unit configured to acquire information about a setting state of the at least one information device from the at least one information device;
an assessment processing unit configured to assess setting contents of the at least one information device based on the acquired information about the setting state of the at least one information device and generate assessment result information; and
a transmitting unit configured to transmit the assessment result information generated by the assessment processing unit to the information management apparatus connected via the second network,
the information management apparatus including:
a receiving unit configured to receive the assessment result information from the information assessment apparatus; and
an output unit configured to output assessment-result output information containing findings on setting contents in a management area, in which the at least one information device is arranged, based on the received assessment result information.

2. The information assessment system according to claim 1, wherein the assessment processing unit includes:
an assessment unit configured to generate a primary assessment result for each of the at least one information device based on the acquired information about the setting state of the at least one information device; and
a generation unit configured to generate, as the assessment result information, a secondary assessment result containing the findings on the setting contents in the management area based on the primary assessment result for each of the at least one information device associated with the management area.

3. The information assessment system according to claim 1, wherein
the assessment processing unit includes an assessment unit configured to generate, as the assessment result information, a primary assessment result for each of the at least one information device based on the acquired information about the setting state of the at least one information device, and
the information management apparatus further includes a generation unit configured to generate, as the assessment-result output information, a secondary assessment result containing the findings on the setting contents in the management area based on the primary assessment result for each of the at least one information device associated with the management area.

4. The information assessment system according to claim 1,
wherein the receiving unit receives an instruction to change a setting based on the assessment-result output information from a user, and
the output unit transmits a request to change the setting to the information device which is requested to change the setting, based on the instruction.

5. The information assessment system according to claim 1, wherein
the output assessment-result output information is fed to an assessment-result providing apparatus configured to provide a user interface for viewing the assessment result, and
an instruction to change a setting entered by a user to the assessment-result providing apparatus is transferred to the information management apparatus.

6. The information assessment system according to claim 5, wherein the assessment-result providing apparatus includes:
a providing unit configured to present the assessment-result output information output from the information management apparatus in a form allowing the user to view the assessment-result output information; and
an accepting unit configured to accept an instruction to change a setting based on the assessment-result output information from the user.

7. The information assessment system according to claim 2, wherein
the at least one information device includes a plurality of information devices,
the generation unit generates a per-management-area secondary assessment result by integrating primary assessment results of the plurality of the information devices associated with the management area, and
in integrating the primary assessment results, a conformance state farthest from a conformance level for a predetermined assessment item among the assessment results of the plurality of information devices is determined as an overall result.

8. An information assessment apparatus connected to at least one information device via a first network and connected to an information management apparatus via a second network, the information assessment apparatus comprising:
an acquisition unit configured to acquire information about a setting state of the at least one information device from the at least one information device;
an assessment processing unit configured to assess setting contents of the at least one information device based on the acquired information about the setting state of the at least one information device and generate assessment result information; and
a transmitting unit configured to transmit the assessment result information generated by the assessment processing unit to the information management apparatus connected via the second network,
the information management apparatus outputting assessment-result output information containing findings on setting contents in a management area, in which the at least one information device is arranged, based on the assessment result information received from the information assessment apparatus.

9. The information assessment apparatus according to claim 8, wherein the information assessment apparatus is any one of the at least one information device to be managed.

10. An information assessment method carried out between an information assessment apparatus and an information management apparatus, the information assessment device being connected to at least one information device via a first network and connected to the information management apparatus via a second network, the information assessment method comprising:
acquiring, by the information assessment apparatus, information about a setting state of the at least one information device from the at least one information device via the first network;
generating, by the information assessment apparatus, assessment result information by assessing setting contents of the at least one information device based on the information about the setting state of the at least one information device acquired at the acquiring;
transmitting, by the information assessment apparatus, the generated assessment result information to the information management apparatus connected via the second network;
receiving, by the information management apparatus, the assessment result information from the information assessment apparatus; and
outputting, by the information management apparatus, assessment-result output information containing findings on setting contents in a management area, in which the at least one information device is arranged, based on the assessment result information.

11. The information assessment method according to claim 10, wherein the generating includes:
generating, by the information assessment apparatus, a primary assessment result for each of the at least one information device based on the acquired information about the setting state of the at least one information device; and
generating, by the information assessment apparatus, as the assessment result information, a secondary assessment result containing the findings on the setting contents in the management area based on the primary assessment result for each of the at least one information device associated with the management area.
